(19) United States
(12) Patent Application Publication
(10) Pub. No.: US 2009/0019489 A1
(43) Pub. Date: Jan. 15, 2009

(54) Method and apparatus for displaying movie titles based on distributed objects

(75) Inventors: Keith R. Ohlfs, (US); Prasanna Ganesan, Menlo Park, CA (US); Tony Miranz, Palo Alto, CA (US); Alain Rossmann, Palo Alto, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: VVOND, Inc.

(21) Appl. No.: 11/226,625

(22) Filed: Sep. 13, 2005

Related U.S. Application Data
(63) Continuation-in-part of application No. 11/075,573, filed on Mar. 9, 2005.

(51) Int. Cl. H04N 5/445

(52) U.S. Cl. 725/44

(57) ABSTRACT

Techniques for displaying a library of many movies and providing interactive mechanisms for users to browse the library, select or order a title are disclosed. In one embodiment, data pertaining to a title is distributed across a network. Whenever a movie is ordered, depending on implementation, either a leading portion of the data locally cached is played back or a time-fill program is activated during which distributed data is fetched as data streams from a set of designated boxes. In addition, movie titles are presented or displayed in movie banners, each resembling at least part or all of a corresponding movie poster distributed and promoted commercially by a studio or production company. Such a movie banner provides an expression with substantially similar style, colors and background such that a coincident impact may be created on audience when the movie banner is seen. Further each of the banners is embedded with a link that leads to a full review of the movie when selected.

### CROSS-REFERENCE TO RELATED APPLICATION

This is a continuation-in-part of co-pending U.S. application Ser. No. 11/075,573, entitled “Continuous data feeding in a distributed environment” and filed Mar. 9, 2005, and by at least one of the co-inventors herein.

### BACKGROUND

1. Technical Field

The present invention relates generally to the display of information on display screens, and more particularly to techniques for displaying movie titles based on distributed objects.

2. Description of the Related Art

When television was first introduced, there were a limited number of channels available. There was no electronic means to display programs being offered in all channels. The only browsing mechanism available was a mechanic switch to allow viewers to switch from one channel to another. As technologies have been advanced progressively, digital television, such as satellite and digital cables, has been introduced and now offers a few hundreds of channels. The browsing mechanism has also been improved and now allows viewers to select a particular program much more intelligently. For example, a particular channel or program can be readily determined from a browseble program guide. FIG. 1A shows a program guide 100 offered by Comcast digital cable. The program guide 100 provides a number of categories from which a user may interactively select a desired one. FIG. 1B shows a list 110 of movies that are being shown in respective channels as a result of the user selecting “Action” in the program guide 100 of FIG. 1A. If the use wants to watch one of the movies in the list 110, the desired movie title may be activated.

It is noticed, however, that unless the user is familiar with the movie it is hard for the user to know what the move is about by looking at the title in words. In general, a movie title is in abstract form and does not indicate much literally. When there is a movie library of many titles, there is a great need for displaying the movie titles in a manner that immediately familiarizes viewers with any particular movie being selected.

Customer appeal of “video-on-demand” is well known. Ideally, a user browses a displayed program guide and selects a desired title for order. The order is sent to a service provider. Moments later, the ordered title is played back. The current architecture is to have a server or a set of servers store all movies and stream a selected movie to the premise of the user while the movie is being viewed. However, given the many shortcomings of today's technology and network-related infrastructure, such architectures of video-on-demand will not be available to the general public till faster and significantly more reliable and predictable communication channels (e.g., fiber optics) are actually deployed.

FIG. 1C illustrates an overview of current video-on-demand architecture. A video delivery system 120 is provided for delivering video services over a network. The video delivery system 120 includes a video server 122 that is sometimes referred to as a head-end. Through a data network 124, the video server 122 can provide continuous, scheduled and video-on-demand (VOD) services to respective client machines 126-1, 126-2, . . . 126-n (i.e., its subscribers). Hence, the system 120 is a typical client-server architecture with one server 122 serving a plurality of client machines 126-1, 126-2, . . . 126-n. The server 122 is further coupled to a media storage device 112 that may be configured to store various media files (e.g., movies or news footage). The media storage device 112 must be on-line and must store and supply titles scheduled or demanded for delivery to any of the client machines 126-1, 126-2, . . . 126-n.

To ensure the quality of service (QoS), the bandwidth requirement of the network path (e.g., 128-1, 128-2, . . . 128-n) to each of the client machines 126-1, 126-2, . . . 126-n has to be sufficient. However, as the number of the subscribers continues to increase, the demand on the bandwidth of the backbone network path 130 increases linearly, and the overall cost of the system 120 increases considerably at the same time. If the server has a fixed bandwidth limit and system support capability, an increase in the number of subscribers beyond a certain threshold will result in slower transfer of data to clients. In other words, the transmission of the video data over the network 124 to the subscribers via the client machines 126-1, 126-2, . . . 126-n is no longer guaranteed. When the video data is not received in a client machine on time, the display of the video data may fail or at least become jittery.

To alleviate such loading problems to the video server 122, a video delivery system often employs multiple video servers, perhaps in multiple locations. Each of the video servers, similar to the video server 122, is configured to support a limited number of subscribers. Whenever the number of subscribers goes beyond the capacity of a video server or the bandwidth thereof, an additional video server needs to be deployed or additional bandwidth needs to be allocated. Subsequently, the overall costs can go up considerably when more subscribers sign up with the video delivery system 120.

There, thus, is a great need for a VOD system that is relatively independent from the number of users. Given a large number of titles in a library in the VOD system, there exists a further need for an interactive interface that facilitates selection and ordering of any of the titles in the library.

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to techniques for displaying a library of many movies, providing interactive mechanisms for users to browse the library, select or order a title. According to one aspect of the present invention, movie titles are presented or displayed in movie banners, each resembling at least part or all of a corresponding movie poster distributed and promoted commercially by a studio or production company. Such a movie banner provides an expression with substantially similar style, colors and background such that a coincident impact may be created on the audience when the movie banner is seen. Further each of the banners is embedded with a link. Once one of the banners is selected, a full review of the movie is provided.

According to another aspect of the present invention, a full review of the movie includes comprehensive information in one display about the movie to facilitate a user to make a decision. In one embodiment, a full review of the movie includes one or more of a trailer that can be manually or automatically played, a full movie poster and/or a slideshow of certain images from the movie, and a brief description, a rating grade, an exact running time, and a production company of the movie, all in one display.

According to still another aspect of the present invention, a user is allowed to browse the library anytime, even during a show, an iconic display is provided to show what is being played so that the user would not miss any part of the show while performing other tasks. Such an iconic display may be embedded in, superimposed upon or inserted in, whenever or wherever appropriate, a display the user has reached. Depending on implementation, the iconic display may continue or pause the movie being watched. In the case that a movie is paused, the iconic display shows a still image that may be a snapshot of a frame at the time the movie is paused. In a preferable embodiment, the iconic display can be activated to continue the movie in full screen.

According to still another aspect of the present invention, various search methods are provided to facilitate a user to search a desired movie based on genres, directors, main characters, and other movie related information. In one embodiment, a logic operation is provided to determine a collective search criterion based on multiple criteria. Although it is possible to display results in words, according to one embodiment, movie titles from a search process are shown in movie banners.

According to still another aspect of the present invention, a notification space is provided and used to inform users of various events, updates or commercial promotions. According to one embodiment, the notification space is auctioned among sponsors that hope to display their respective programs to audience. When the notification space is used to promote new releases, full posters of the new releases are distinctly displayed, each being embedded with a link. Once one of the posters is selected, a full review of the movie is provided.

According to still another aspect of the present invention, a time-fill program is played before an ordered movie is started. Similar to watching a movie in a movie theater, the time-fill program provides a number of previews of upcoming new releases. The time-fill program may be locally configured. In one embodiment, the time-fill program is used to stabilize data being fetched from one or more other devices. In another embodiment, the time-fill program provides a platform for sponsors that hope to display their respective programs to audience. Orders or slot positions for these programs in a time-fill program may be auctioned.

According to yet another aspect of the present invention, a leading portion of data pertaining to a movie is locally cached and immediately played back when the movie is ordered. During the time the leading portion of data, distributed data is concurrently fetched from one or more other devices and assembled with local data, if any. As soon as the leading portion of data is done, the assembled data is played back to succeed the playback of the ordered movie.

Other aspects of the invention will become apparent and appreciated by those skilled in the art from the detailed description herein. Embodiments of the invention may be implemented in numerous ways, including a method, system, device, or a computer readable medium. Several embodiments of the invention are discussed below. According to one embodiment, the invention provides a method for displaying movie titles in a library, the method comprises displaying on a display screen a home display after a user is authorized to access the library including a plurality of movie titles, the home display including an interactive functional panel and a notification space, wherein the interactive functional panel provides a list of functions from which the user can at least archive some of the movie titles, browse the movie titles, and search or order one of the movie titles, and displaying the movie titles in movie banners in accordance with one of the functions. After one of the movie banners is selected (hereinafter “selected movie banner”) for ordering and requested for viewing, if an instantaneous playback feature is implemented, a locally cached header pertaining to the selected movie banner is instantaneously played back. Otherwise, a time-fill program is activated. Further an iconic window is provided wherever appropriate to show a movie if there is such a movie that is being played.

According to another embodiment, the invention provides an apparatus for displaying movie titles in a library, the apparatus comprises a memory for storing at least an application module, a processor, coupled to the memory, executing the application module to perform operations of: displaying on a display screen a home display after a user is authorized to access the library including a plurality of movie titles, the home display including an interactive functional panel and a notification space, wherein the interactive functional panel provides a list of functions from which the user can at least archive some of the movie titles, browse the movie titles, and search or order one of the movie titles. The operations further comprises displaying the movie titles in movie banners in accordance with one of the functions; and after one of the movie banners is selected (hereinafter “selected movie banner”), playing back instantaneously a locally cached header pertaining to the selected movie banner, if an instantaneous playback feature is implemented, or activating a time-fill program if a delayed playback feature is implemented.

Accordingly one of the objects of the present inventions is to provide techniques for displaying and facilitating to browse a large number of movie titles in a library. Other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows a program guide offered by Comcast digital cable;

FIG. 1B shows a list of movies that are being shown in respective channels as a result of the user selecting “Action” in the program guide of FIG. 1A;

FIG. 1C illustrates an overview of current video-on-demand architecture;

FIG. 2A shows an exemplary display showing a list of services provided by a service provider;

FIG. 2B shows an exemplary display, also referred to as a home display, that may be provided after the user enters Watch a Movie of FIG. 2A;

FIG. 2C shows a display including a list of movie titles in My Movies, wherein the movie titles are presented respectively in movie banners;

FIG. 2D shows a display including a viewing history in My Movies to show what movie a user has ordered or watched;

FIG. 3A shows a display including an exemplary full review of a selected movie;

FIG. 3B shows a display that includes an optional panel provided to allow the user to adjust sound control of the trailer being played in a full review of a movie, present additional information about the movie, and enable additional functionality such as the ability to watch the trailer in full-screen mode;

FIG. 3C shows a display including a list of movies conducted by the same director of the movie being reviewed in the full review;

FIG. 4A shows an exemplary display including a browsing panel providing several search schemes to facilitate a search process;

FIG. 4B shows a display after a user chose New Releases and Top Rated in the browsing panel of FIG. 4A;

FIG. 4C and FIG. 4D show respectively a display that provides an alphabetic keypad to allow a user to enter characters or texts to conduct a progressively focused search;

FIG. 5A shows an internal functional block diagram of an exemplary terminal device (e.g., a computing device, a set-top box, and a television);

FIG. 5B shows a minimum time frame for a time-fill program to run before an order movie starts in a particular terminal device;

FIG. 6A shows an exemplary configuration of distributed video system;

FIG. 6B shows an exemplary source information map illustrating how a library of 5000 titles is distributed across N boxes;

FIG. 6C shows a source information map corresponding to FIG. 6A;

FIG. 7A, according to one embodiment, shows a file organized or fragmented into four segments;

FIG. 7B, according to one embodiment, shows a file organized or fragmented into a header and four segments;

FIG. 7C shows how a file is being fragmented (decimated) according to one embodiment;

FIG. 7D shows an embodiment of retrieving and assembling segments to support a playback of a selected movie; and

FIG. 8A and FIG. 8B collectively show a flowchart or process of playing back a selection (i.e., a title) according to one embodiment of the present invention.

### DETAILED DESCRIPTION OF THE INVENTION

The invention is related to various techniques for displaying a library of many movies, providing interactive mechanisms for users to browse the library, select or order a title. According to one aspect of the present invention, movie titles are presented or displayed in movie banners, each resembling at least part or all of a corresponding movie poster distributed and promoted commercially by a studio or production company. Such a movie banner provides an expression with substantially similar styles, colors and background such that a coincident impact may be created on the audience when the movie banner is seen. Each of the banners is embedded with a link. Once one of the banners is selected, a full review of the movie is provided or a slideshow of certain images from the movie is provided. Different from a prior art system, a full review of a movie in the present invention includes one or more of a trailer that can be manually or automatically played, a full movie poster or a slideshow of certain images from the movie, and a brief description, a rating grade, an exact running time, and a production company of the movie, all in one display. Other aspects, features, benefits and advantages of the invention will become apparent from the following detailed description taken in conjunction with the accompanying drawings which illustrate, by way of example, the principles of the invention.

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

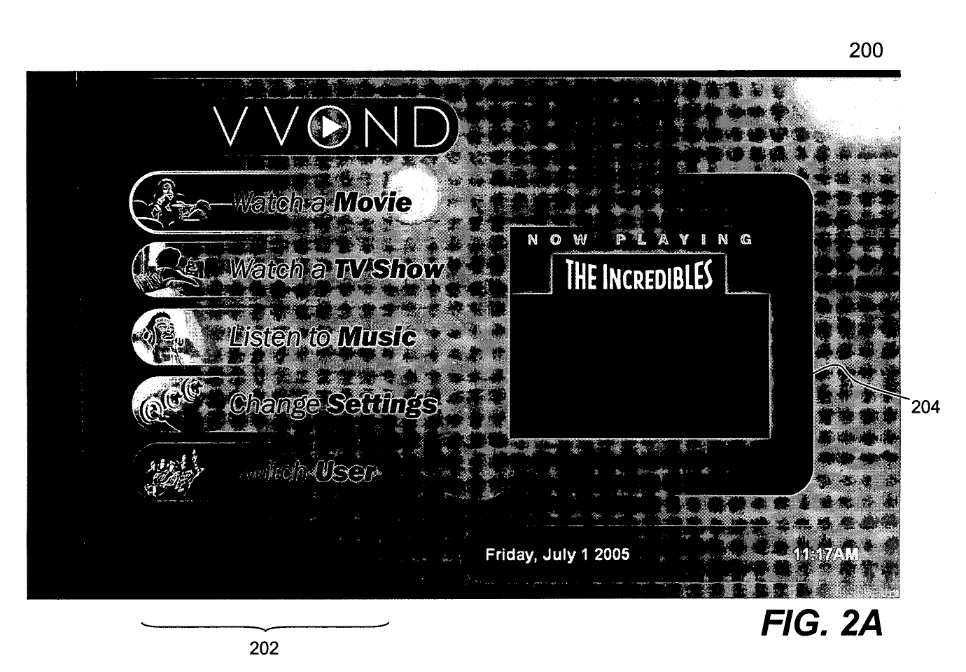

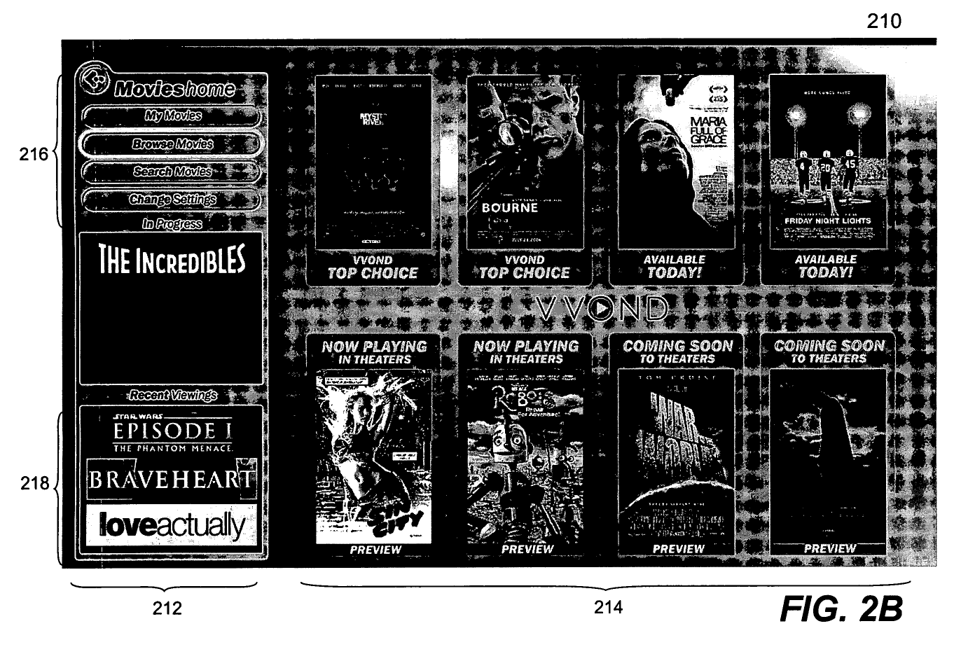

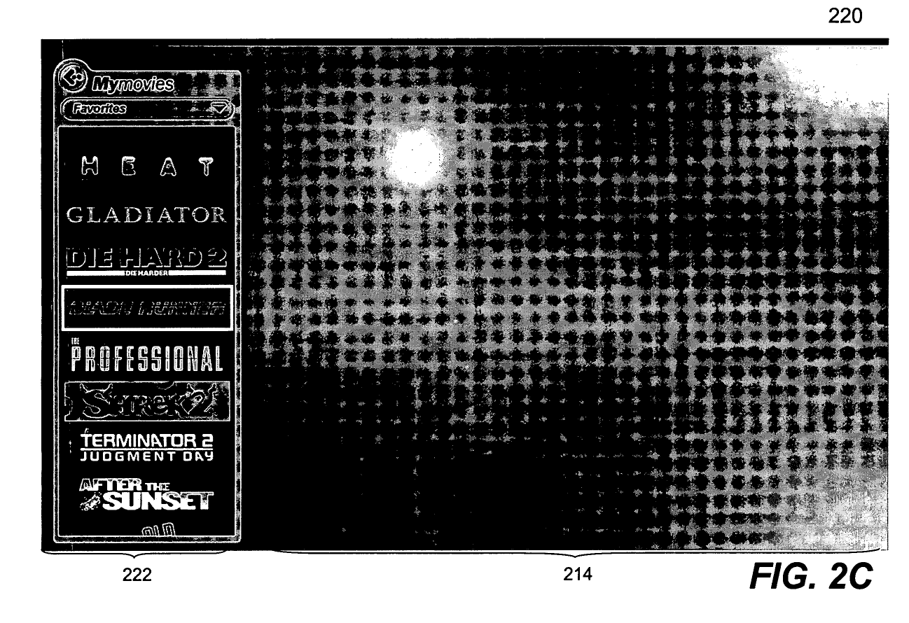

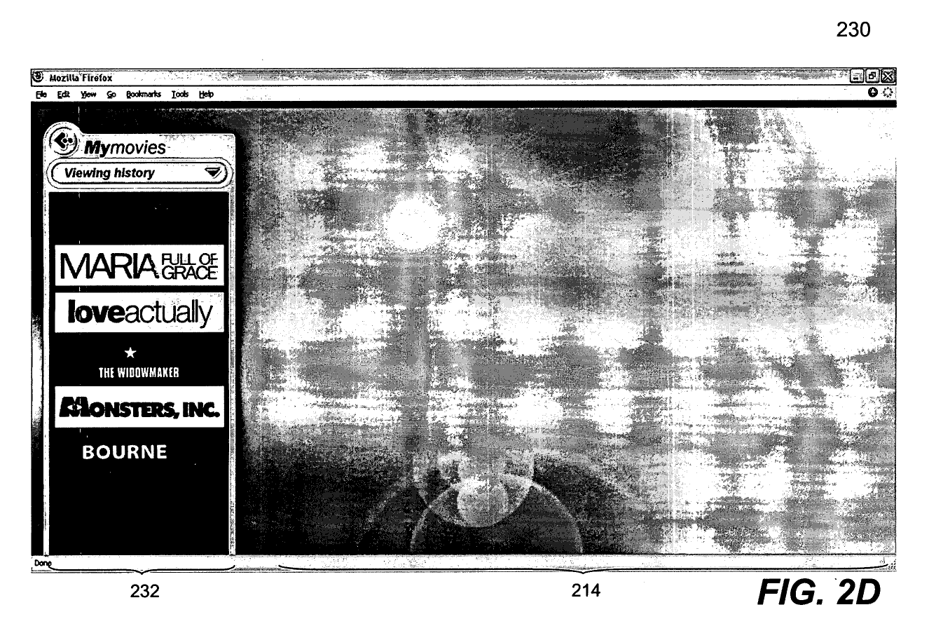

Referring now to the drawings, in which like numerals refer to like parts throughout the several views. FIG. 2A shows an exemplary display 200 providing a list 202 of services provided by a service provider. The display 200 and any subsequent displays are images displays on a display screen that may be part of a computing device or a television, or coupled to a device. It should be noted that it is defined herein a display screen or a screen is a physical display apparatus such as a CRT or LCD television commonly seen and available. A screen display or simply a display is a displayed image or a displayed window presented on the display screen.

The display 200 shows that a user may enter into any of five areas: Watch a Movie, Watch a TV Show, Listen to Music, Change Settings, and Switch User. As the name suggests, Watch a Movie allows a user to order a movie from a plurality of titles in a library, Watch a TV Show and Listen to Music allow a user to choose a particular channel for TV broadcasts and music, live or archived, Change Settings is provided to change various settings for a particular account from which a user may access the services, and Switch User allows a change from one user account to another. Some of the areas will be detailed below.

Next to the list 202, according to one embodiment, the display 200 includes a smaller display window 204, referred to as an iconic display, showing whatever is being played. The iconic display 204 is created when a user leaves a movie being watched for something else. There are situations in which the user decides to go back to the list 202 (e.g., change a setting or order a different movie). Depending on implementation, the iconic display 204 may continue or pause the movie being watched. In the case that a movie is paused, the iconic display shows a still image that may be a snapshot of a frame at the time the movie is paused. By providing the iconic display 204, the user is reminded of what is being played and can always go back to the show by, for example, clicking on the iconic display 204 to go for full screen. It can be understood that such an iconic display, when appropriate, may be placed on a display whenever a user switches to the display in the middle of the playback of a movie. An activation of the iconic display leads to a restoration of a full display of the movie.

It is assumed that a user enters Watch a Movie. FIG. 2B shows an exemplary display 210, also referred to herein as a home display, after the user enters Watch a Movie. The display 210 includes a functional panel 212 and a notification space 214. The functional panel 212 includes various tools 216 to facilitate a user to manage personalized lists and/or minor accounts if necessary, search a movie and change settings, etc. In addition, the functional panel 212 includes a list of recent movies 218 that the user has viewed. In accordance with FIG. 2A, the movie that is currently being played is displayed in an iconic display 220 that is also included in the functional panel 212.

The notification space 214 is provided to display various promotions. The embodiment as shown in the display 210 shows that there are eight movies being promoted. In another embodiment, the notification space 214 is used to advertise various services and products. These services and products may be highly related to the interests or characteristics of the account owner. When an account is established for the owner, a list of questions may be posed for the owner to answer. The answers from the owner to the questions are assembled and analyzed to determine the interests or characteristics of the owner. For example, some answers indicate that the owner is very much into golfing, the notification space 214 may be configured to display services and products somehow related to golfing. The interests or characteristics of the owner may also be determined from an analysis of the owner's behavior in interacting with the system, together with additional information provided to the system about the behavior of other owners.

According to one embodiment, the notification space 214 provides a platform for businesses to promote or advertise their respective services and products. According to one embodiment, the use of the notification space 214 or the selection of programs to be displayed in the notification space 214 may be determined through an auction process. In others words, a business willing to pay a higher price gets a higher priority to display its service/products in the notification space 214.

As shown in FIG. 2B, the movies being promoted in the notification space 214 are in the form of movie posters. One of the advantages of showing movie posters instead of titles in words is to make a coincident impact on audience as a movie poster is a single visual image representation of a movie. Movie studios or production companies, large or small, promote their movies with movie posters so that the general audience gets to know a movie quickly from a corresponding movie poster. According to one implementation, each of the displayed movie posters in the notification space 214 is embedded with a link. Once one of the displayed movie posters is selected, a full review of the movie is provided.

Different from a prior art system that displays limited information about a movie (e.g., www.movielink.com), a full review of a movie in the present invention provides comprehensive information about the movie to facilitate a user to make a decision. According to one embodiment, a full review of the movie includes a trailer that can be manually or automatically played, a full movie poster and a brief description, a rating grade, an exact running time, a production company of the movie, all in one display. An example of such a full preview will be provided herein and described below.

My Movies, Browse Movies, and Search Movies in the functional panel 212 provide respective mechanisms for a user to locate a movie. My Movies is a personal directory providing a vault to store or bookmark one or more movies favorite to the owner of the account. According to one embodiment, when a user is interested in a movie when browsing the library offered, the movie may be bookmarked in My Movies so that the user can always go back to My Movies to readily place an order for the movie. FIG. 2C shows a display 220 including a list 222 in My Movies. Instead of using words for a title of a movie, the display 220 shows a list of movie banners, each banner representing a visual image of the movie. A movie banner may be part of a corresponding movie poster or a redesigned banner that reflects certain characteristics of the movie.

As shown in the list 222 in My Movies, each of the movie banners shows a title in substantially similar style, font and background as in the corresponding movie poster. It may be appreciated by those skilled in the art that one of the features in the present invention is to create a coincident impact on the audience by using at least part of a movie poster or banner to indicate a movie. In certain aspect, a movie banner is equivalent to a visual “logo” for a movie. A user may browse or scroll the list of movie banners in the list 222. Each of the movie banners in the list 222 is embedded with a link that brings up a full review of the movie when one of the displayed movie banners is selected.

According to one embodiment, after a certain arrangement with the service provider is made, the user may gain a limited right to access one or more movies in My Movies repeatedly without repeated charges or with a nominal change. Depending on implementation, the titles in My Movies may or may not be subject to library updating. In operation, a service provider may update the titles in a library periodically or at a predefined time. When the library is updated, the title bookmarked in My Movies may be affected depending on whether the title is still in the updated library. If the title bookmarked in the My Movies is no longer supported by the updated library, the titles in My Movies may be updated accordingly such that whatever bookmarked in My Movies is always in the library. According to another embodiment, some titles in My Movies are independent from the library in which case a special arrangement has to be made with the service provider to make the data pertaining to the titles available to the user for a predefined period.

FIG. 2D shows a display 230 including a viewing history 232 in My Movies. The viewing history 232 is provided to record what movie the user has ordered or watched. Similar to the favorite list 222 in FIG. 2C, the viewing history 232 shows a list of movie banners reflecting that these movies have been watched or ordered. Each of the movie banners in the list 232 is also embedded with a link that leads to a full review of the movie when activated.

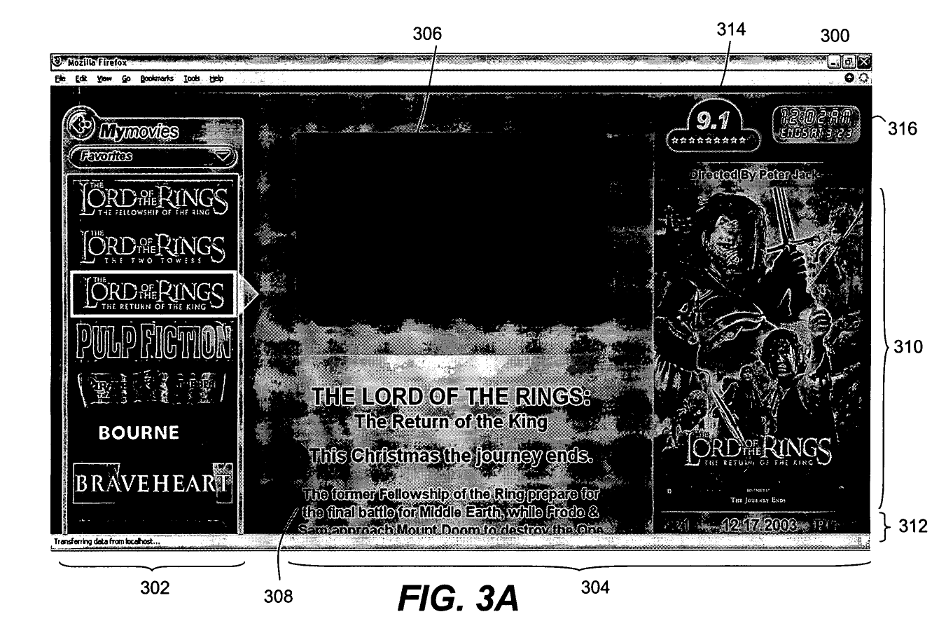

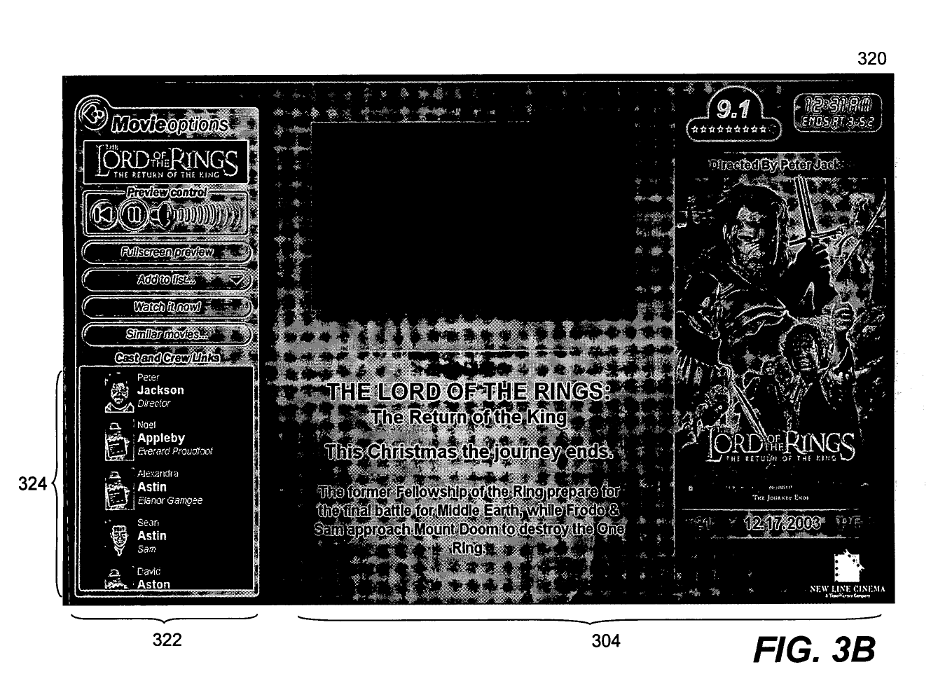

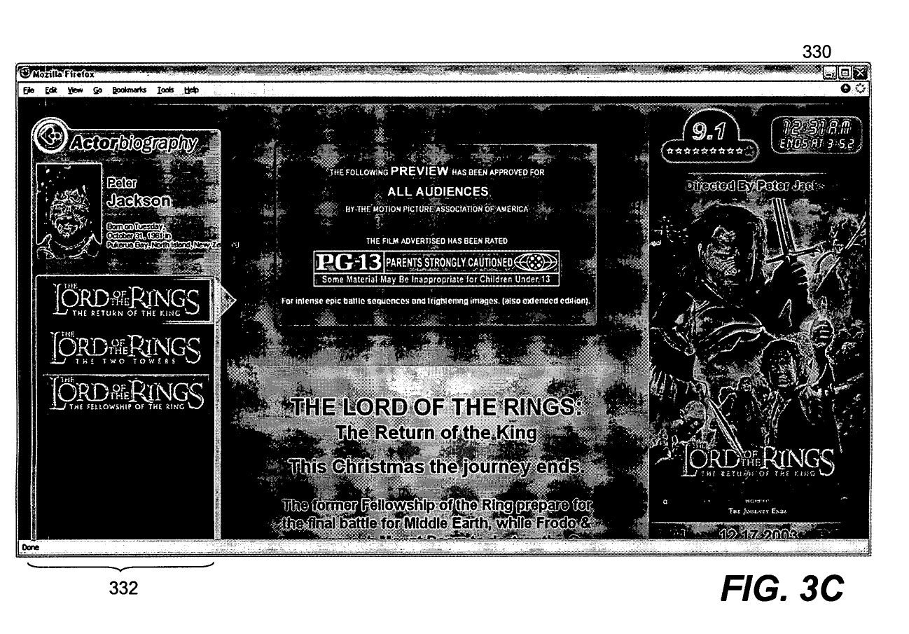

Referring now to FIG. 3A, there shows a display 300 including an exemplary full review 304 of a selected movie. A full review can be displayed whenever a user wants to know something about the movie, for example, a user selects a movie banner in a viewing history 232 of FIG. 2D or a movie poster in notification space 214 of FIG. 2B. FIG. 3A shows that a movie banner in my favorite list 302 is selected. The full review 304 includes a trailer 306 that can be manually or automatically played, a brief description 308 of the movie, a corresponding movie poster 310, and publication information 312 that includes an exact playing time, a publication date and a rating grade. In addition, the full review 304 includes a rating by viewers who have watched the movie and a current time and an ending time if the movie is ordered at the time. One of the features of the full review 304 is that various pieces of information about a movie are integrated in one display so that a user gets to know the movie by one click. According to another embodiment, a full review (not shown) is an interactive page using at least some or all of a corresponding movie poster as the background. Some texts, graphics or icons may be embedded with a corresponding link that brings up a display with more information if activated. For example, a director name in the full review may be activated to bring up a display similar to the one shown in FIG. 3C which will be described below. In addition, such a full review includes a window to show a corresponding trailer or preview. The window may be superimposed on or inserted in wherever appropriate in the background.

FIG. 3B shows a display 320 that includes an optional panel 322. The optional panel allows the user to adjust sound control of the trailer in the full review 304. If the user wants to have a full screen of the trailer, a button Fullscreen preview in the optional panel 322 may be activated. Optionally a designated button on a controller (e.g., remote control) may be pressed. When the user decides to add this chosen move to his/her favorite list, a button Add to list in the optional panel 322 can be activated. As a result, a corresponding movie banner is added to the favorite list, an example of which is shown in FIG. 3A. Should the user decide to order or play back the movie in the full review 304, a button Watch it now in the optional panel 322 may be activated. In operation, when the button Watch it now is activated, the movie is to be played in full screen assuming a type of arrangement (e.g., a payment) has already been made with the service provider. Depending on implementation, after Watch it now is activated, the ordered movie may be started immediately or a time-fill program typically short in time is played before the movie starts. Once the movie is finished, an option may be displayed to allow the user to rent the movie for an extended period or purchase an ownership of the movie, in either case a corresponding movie banner may be placed in my favorite list 302, a personalized list or a list for a personal vault.

To help the user browse in the library that includes many movie titles, the optional panel 322 offers cast and crew links 324. Instead of showing the director, main actors or other characters in words, iconic images about the director, main actors or other characters of the movie in the full review are shown such that the user gets to know these people visually. In one of the embodiments, each of the iconic images is embedded with a link. When one of the iconic images is selected, the underlying link brings up a relevant display about the person. For example, the iconic image for the director Peter Jackson is activated, a display with a brief biography is displayed. FIG. 3B shows an exemplary display 330 including all movies in the library directed by the director Peter Jackson. The list in the panel 332 shows movies directed by the director Peter Jackson. Selecting a movie in this list will also lead to the full review of that movie, thus resulting in an encyclopedic environment where it is possible to jump from movie to actor/director or vice versa in a seamless fashion. It should be noted that various displays pertaining to an iconic image may be possible or designed to get enough attention from the user. Other possible relevant displays include a detailed biography of the director or a website. Similarly, any iconic image for one of the main actors may be activated as well.

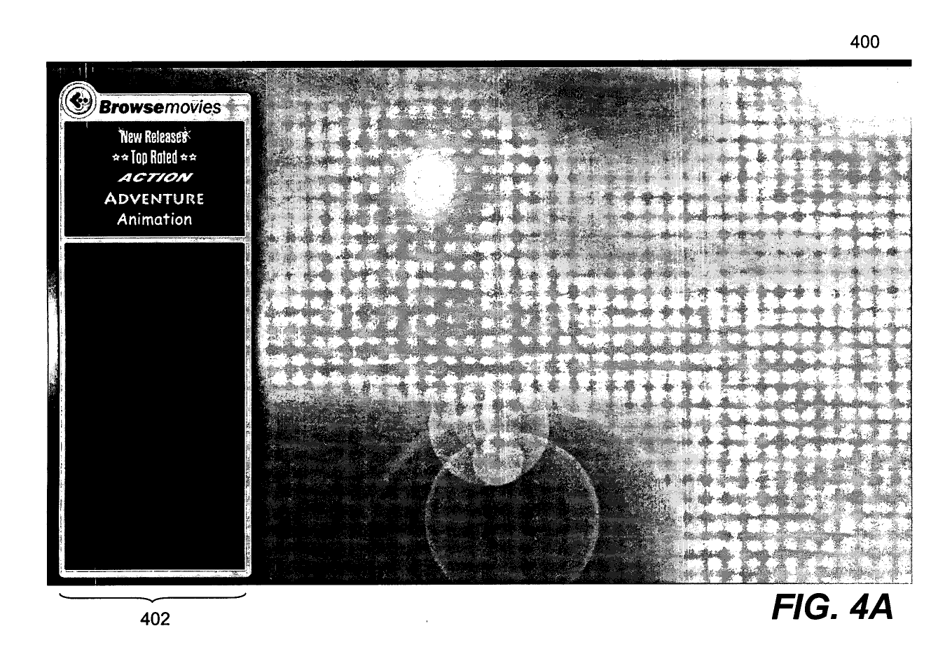

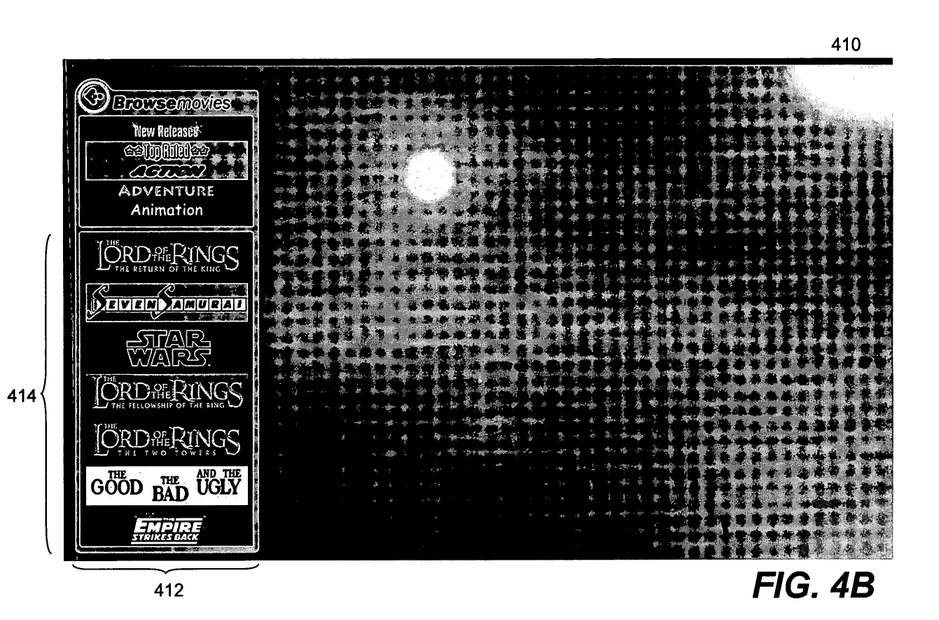

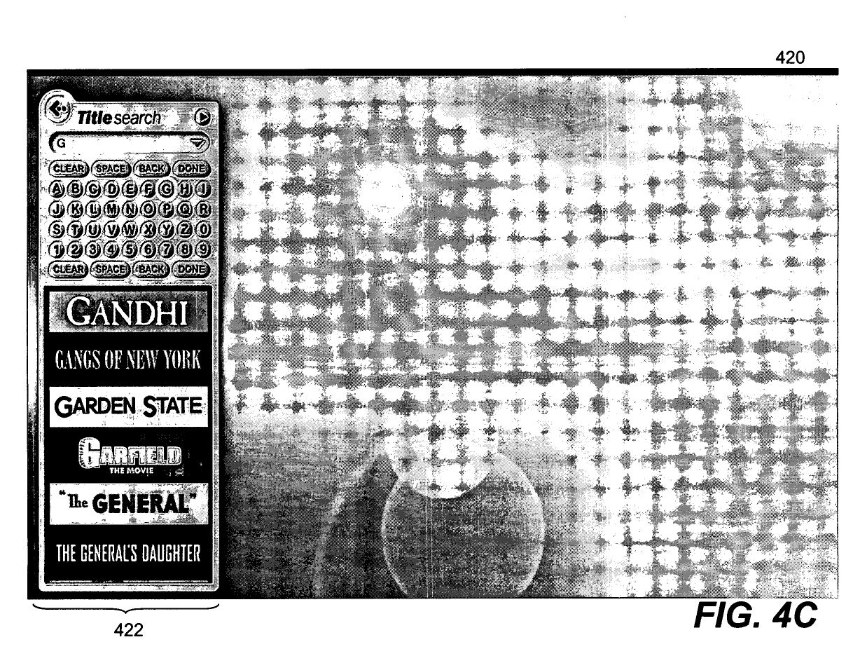

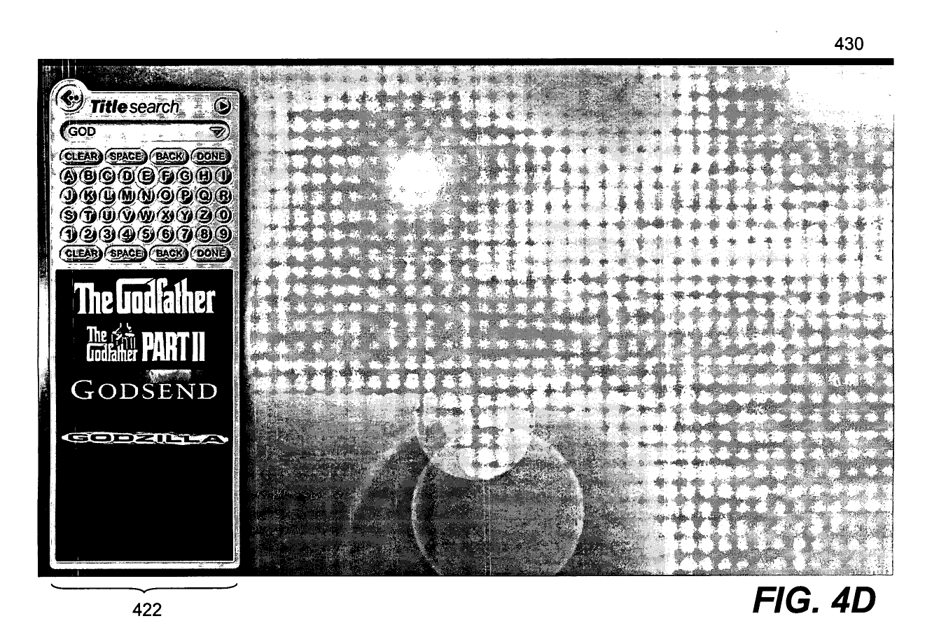

Browse Movies is an interactive mechanism to allow a user to find a movie. Unlike a prior art system in which a user needs to remember a name of a movie, the interactive browsing mechanism according to one embodiment of the present invention provides a number of visual searching tools to help a user to quickly locate what he or she wants. Referring to FIG. 4A, there shows an exemplary display 400 including a browsing panel 402. There are several search schemes that may be provided. According to FIG. 4A, the browsing panel 402 provides searching in a library based on a type or genre of movies. Movie types would include options such as New Releases, Top Rated, '90s movies, '80s movies, oldies, etc. . . . Movie genres may include examples such as Action, Adventure, Animation, Drama, etc. In one embodiment, a logic operation is provided to determine a collective search criterion based on multiple criteria, for example, multiple genres and types provided to lead to a display of titles that match all the genres and types.

FIG. 4B shows a display 410 after a user chose two criteria New Releases and Top Rated in the browsing panel 402 of FIG. 4A. The display 410 shows a list of movies that match both the criteria of New Releases and Top Rated. The display 410 also includes a result panel 414 that shows the list of movies in respective movie banners. When the result panel 414 can not accommodate all the movie banners, the result panel 414 is configured automatically to be scrollable. In other words, a user may scroll, continuously or page by page, a panel to view all titles listed. In addition, the titles in the panel may be sorted by rating, year or alphabetically.

In operation, the list of movies in New Releases, Top Rated or the result panel 414 is subject to change. Whenever a library being offered is updated, the list of movies is updated. As a result, titles labeled by New Releases or Top Rated may change as well. According to one embodiment, each of the movie banners in the result panel 414 is embedded with a link. When one of the movie banners is activated, the underlying link brings up a full review of the movie.

FIG. 4C shows a display 420 that provides another search mechanism. The search panel 422 provides an alphabetic keypad 424 to allow a user to enter characters or texts sequentially. The movies with titles matching the inputted characters or texts partially or completely are displayed in the result panel 426. As shown in FIG. 4C, a first character “G” is selected, thus movies with titles having the character “G” are selected and corresponding movie banners are displayed in the result panel 426.

As the user inputs more characters, the search becomes more focused. Accordingly, the list in the result panel 426 becomes progressively reduced. When the second character the user has inputted is “O”, the movies with titles that do not match the characters “GO” will be removed from the result panel 426. FIG. 4D shows a display 430 after the user has inputted three characters “GOD” which resulted in four movies in the result panel 426.

Unlike the characters in a word, there is no specific order as far as words are concerned. To reach all movies possible, according to one embodiment, there is no specific order of the word inputs with respect to the title. A user may input “Love How” or “How Love” in either which case the movie “Dr. Strangelove or: How I Learned to Stop Worrying and Love the Bomb” will be listed in the result panel 426.

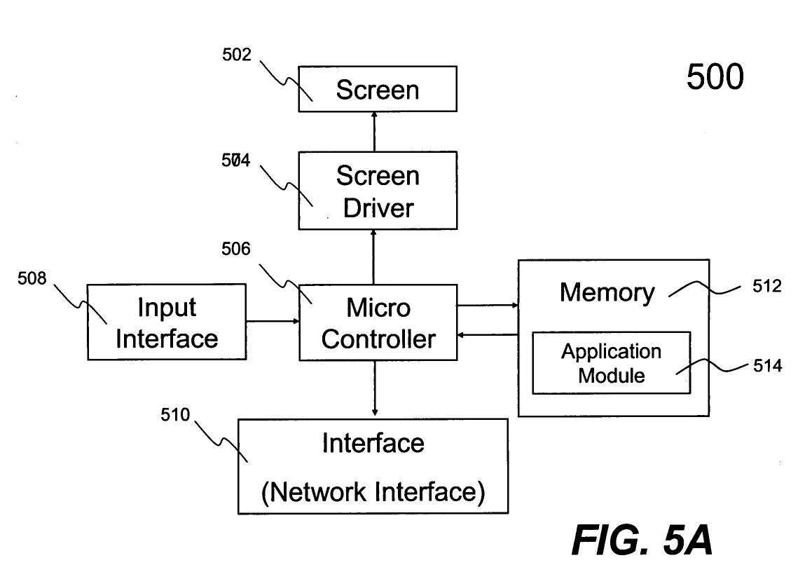

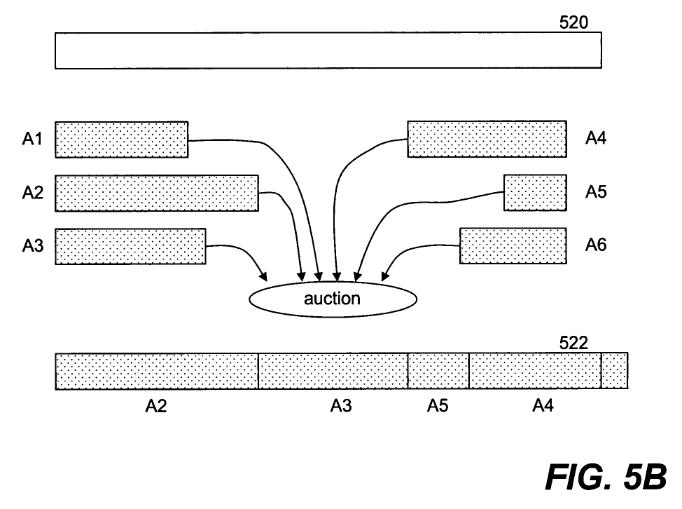

Now referring to FIG. 5, there shows an internal functional block diagram of an exemplary terminal device 500, which may correspond to a computing device, a set-top box, and a television. The screen 502 may be a LCD screen or part of a device (e.g., a television). The screen 502 communicates with and is commanded by a screen driver 504 that is controlled by a microcontroller (e.g., a processor) 506. The memory 512 may be loaded with one or more application modules 514 that can be executed by the microcontroller 506 with or without a user input via the user interface 508 to achieve desired tasks.

In one embodiment, an application module loaded in memory 512 is configured to facilitate a search throughout the movie titles in a library in accordance with characters or words received from the input interface 508 that supports various input devices implemented in hardware or software. Examples of such input devices include a keyboard, an alphabetic keypad, a remote controller, a voice-command controller, or a tracking or scrolling mechanism. In operation, when a user elects to display a search panel, the microcontroller 506 executes the application module to facilitate a search process. In reference to FIG. 4C, an interactive alphabetic keypad is provided and displayed on the screen 502 via the screen driver 504.

According to another embodiment, an application module loaded in memory 582 is configured to facilitate various payment operations. In one exemplary operation, the application module controls the access to a title in a library and allows the access only when the application module is notified or ensured that a payment is settled with a business entity (e.g., the service provider).

According to still another embodiment, an application module loaded in memory 582 is configured to assemble a time-fill program before the start of a movie. As the name suggests, a time-fill program, typically short in time, may be used to inform users of various events, updates or commercial promotions. Depending on implementation, a time-fill program may be assembled differently from one service provider to another. As an example, FIG. 5B shows a time frame 520 for a time-fill program for a particular terminal device. The time frame 520 defines a minimum time the device needs to stabilize data that is being collected or streamed in for playback of an order. It is assumed that there are six commercial programs A1, A2, A3, A4, A5 and A6 that are locally available for assembling the time-fill program. To convey the information efficiently, the programs may be different in length. Given the time frame 520, it is not likely to put all of the six programs in the time-fill program. According to one embodiment, an auctioning mechanism is provided to allow sponsors of these programs to decide when and how their programs are shown to a user. The service provider may determine a respective price for each of the slots in the time-fill program. Typically the first slot is the most expensive as a program gets most attention from a user after the user has just placed an order.

FIG. 5B shows that the sponsors of programs A2, A3, A5 and A4 desire respectively the first slot, the second slot, the third slot and the fourth slot in the time-fill program. It should be noted that the determination or acceptance of a program for the last slot (e.g., the fourth slot) is subject to the time frame 520. In operation, it is not desirable to exceed too much the time frame 520 in order to accommodate all desired commercial programs. The assembled time-fill program 522 in FIG. 5B shows that a small extended time beyond the time frame 520 is added to include a complete program A4.

According to still another embodiment, an application module loaded in memory 582 is configured to track the display or where a movie is being played. Although it is rare in practice, the application module facilitates a speedy recovery or a restart of where the movie had stopped should the terminal device crash.

In addition, the terminal device 500 includes an interface 510 that facilitates wired/wireless communication with one or more other devices. In one embodiment, various commands are sent via the interface 510 (e.g., a RF interface).

In another embodiment, some or all of the data pertaining to a movie being chosen to play are fetched from a server or one or more other boxes via the interface 510 (e.g., a network interface).

There may be many mechanisms or methods that may be implemented to interact with the displays described herein. In one embodiment, each of the displays described herein can be arrived, scrolled, browsed or activated by a remote device with a scrolling mechanism (e.g., a wheel). A user may navigate a display or scroll up or down a list by rolling the scrolling mechanism, and activate a link, enter a character or execute a command by pressing the scrolling mechanism, another key or button.

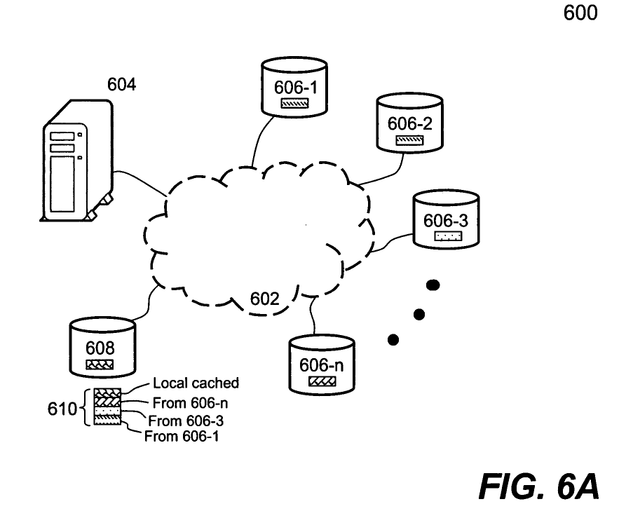

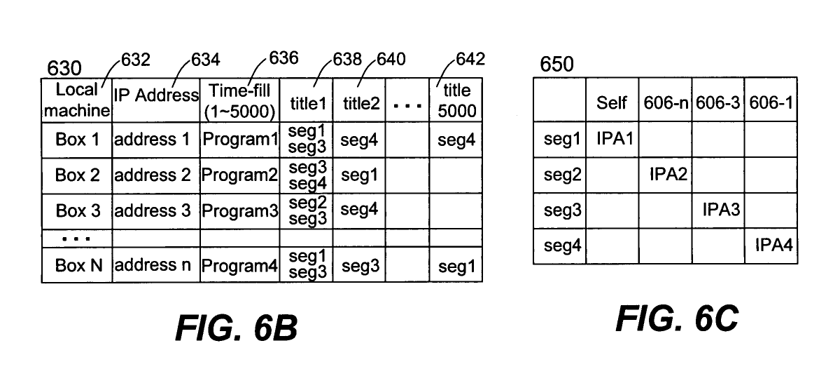

Referring now to FIG. 6A, there shows an exemplary configuration 600 of distributed video system. Coupled to the network 602, there are a server 604 and a plurality of local machines or boxes 606-1, 606-2, 606-3, . . . 206-n and 608. Each of the boxes 606-1, 606-2, 606-3, . . . 206-n and 608 includes or connected to a display screen (not shown). In one embodiment, each of the boxes 606-1, 606-2, 606-3, . . . 206-n and 608 is implemented in accordance with the internal functional block diagram as shown in FIG. 5A.

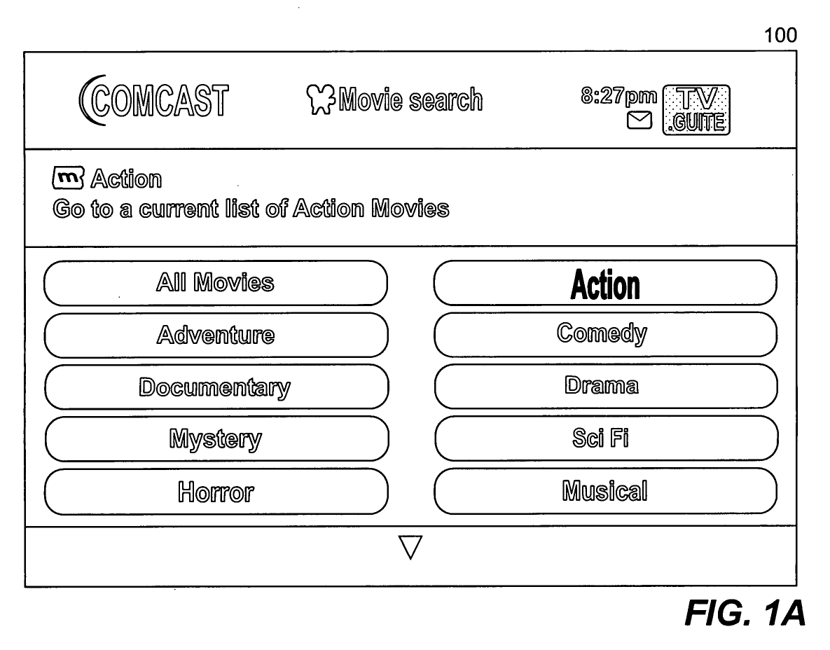

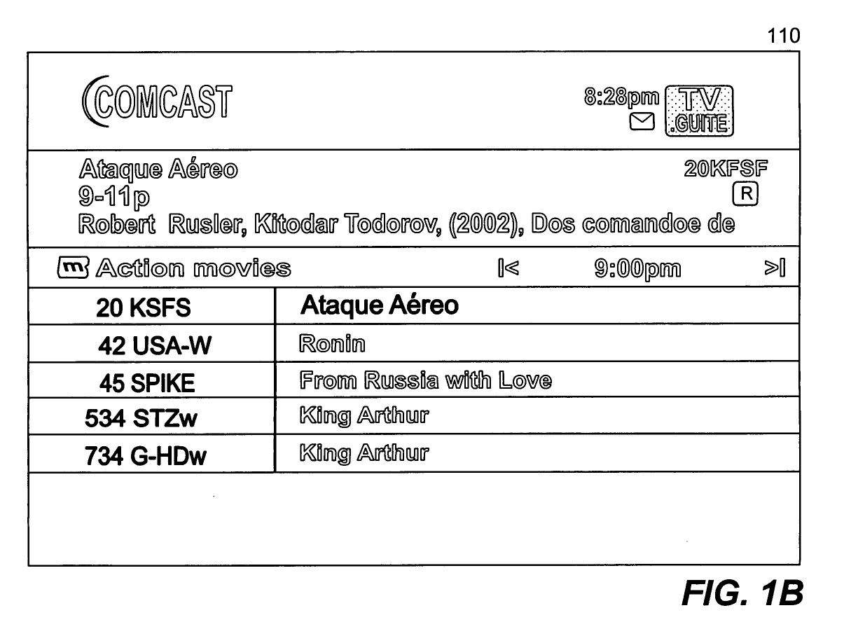

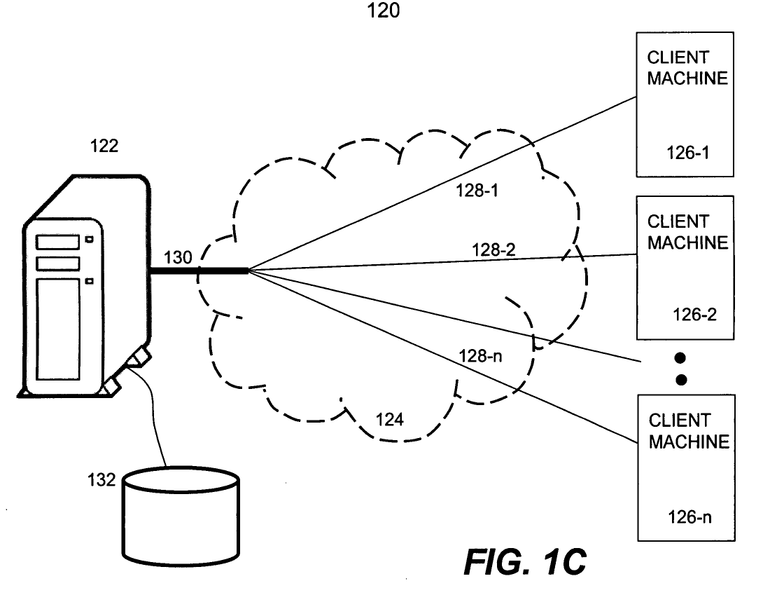

Significantly different from the video server 122 of FIG. 1C that centrally stores all video data and delivers a set of video data pertaining to an ordered title to a subscriber upon receiving a request therefrom, the server 604, presumably managed and/or populated by a service provider, is configured to handle the delivery of video (or multimedia) data to a subscriber via local machines or boxes 606-1, 606-2, 606-3, . . . 206-n and 608. In other words, all video data is distributed among all boxes in service and the server 604 is not required to deliver all the data in response to a request from a user, and instead is configured to provide source information as to where and how to retrieve some or all of the data from other boxes. Of course, it may be possible to use server 604 in a more traditional fashion to deliver some or all of the data as well.

According to one embodiment, the box 608 places an order for a selected title. Specifically the display 320 of FIG. 3B is displayed, a user activates “Watch It Now”. It is assumed that a financial arrangement is already in place, the box 608 sends a request to the server 604. When fulfilling the request from the box 608, the communications between the server 604 and the box 608 over the network 602 are typically small in data size and short in time. In operation, a response by the server 604 to a request from a box may include source information (e.g., identifiers), authorization information and security information. Using the response from the server 604, the box 608 may be activated to begin initiating one or more requests to other boxes (e.g., 606-2 and 606-n) in accordance with the source identifiers. Alternatively, a set of designated boxes may be activated in response to the server to start uploading needed data to the ordering box.

As used herein, a file for a movie is a collection of media or video data including all possible auxiliary data. In accordance with the present invention, a file pertaining to a movie is fragmented into several segments. Depending on the popularity of the title, none or at least one of the segments are distributed in some or all of the boxes in service. To playback an ordered title successfully, those remotely distributed segments must be retrieved and assembled with any local cached segments if any. As shown in FIG. 6A, a file 610 for an ordered movie title is fragmented into four segments. The first segment is locally cached. The second segment is distributed at least in the box 606-n, the third segment is distributed at least in the box 606-3, and the fourth segment is distributed at least in the box 606-1 and 606-2.

After proper authorization, the ordering box 608 starts to receive the distributed segments concurrently in accordance with the source information determined by the server 604. FIG. 6B shows exemplary source information shown as a map 630 illustrating how a library of 5000 movie titles is distributed across N boxes. Column 632 lists all boxes in service. Each box is assigned a unique identifier for identification. Information in the column 632 may be viewed as the identifiers for the boxes in service. For example, box 1 is assigned a unique identifier of “Box 1” or a sequence of alphanumeric characters. The column 634 lists a corresponding IP address for each of the boxes listed in column 632. The Column 636 lists predetermined time-fill programs for all titles in the library. Depending on implementation, the time-fill programs may be identical or each of the time-fill programs is self-configured in accordance with what has been ordered. The column 638 lists what segments for title1 are residing in each of the boxes, assuming title1 is required to have two segments cached in each box. The column 640 lists what segment for title2 is residing in each of the boxes, assuming title2 is required to have one segment cached in each of the boxes. The column 642 lists what segment for title5000 is in a selected set of boxes, assuming title5000 is required to have one segment in these selected boxes. As a result, all segments in a box may be uniquely addressed for uploading to another box or playback of an ordered title locally.

FIG. 6C shows a source information map 650 corresponding to FIG. 6A. There are three other boxes 606-n, 606-3 and 606-1 designated to supply the needed three segments that are together assembled with the locally cached segment to facilitate the playback of the ordered movie. It can be appreciated that relying on multiple sources to retrieve distributed objects to support a playback can be advantageously used in the architecture of current networks where the downloading bandwidth is typically a multiple of the uploading bandwidth.

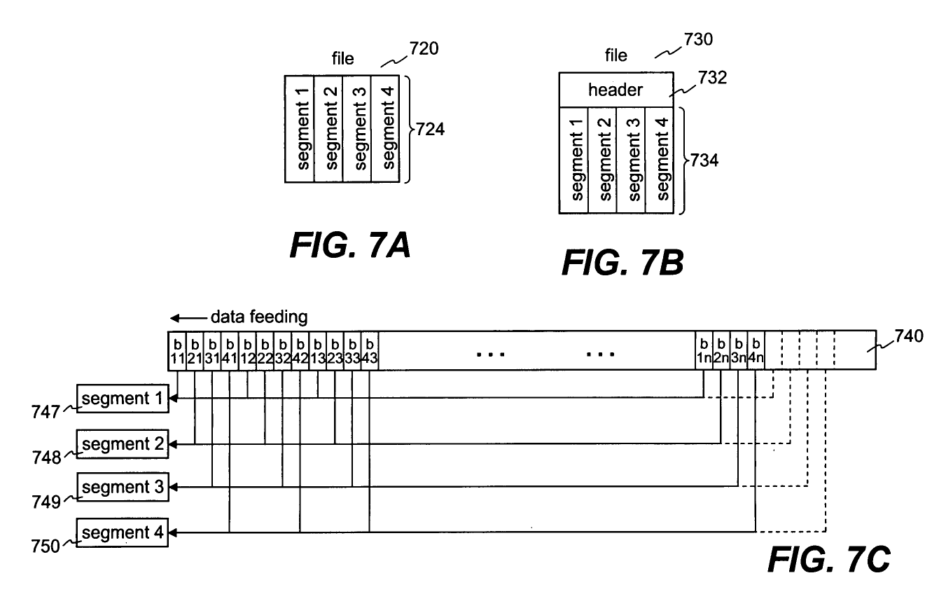

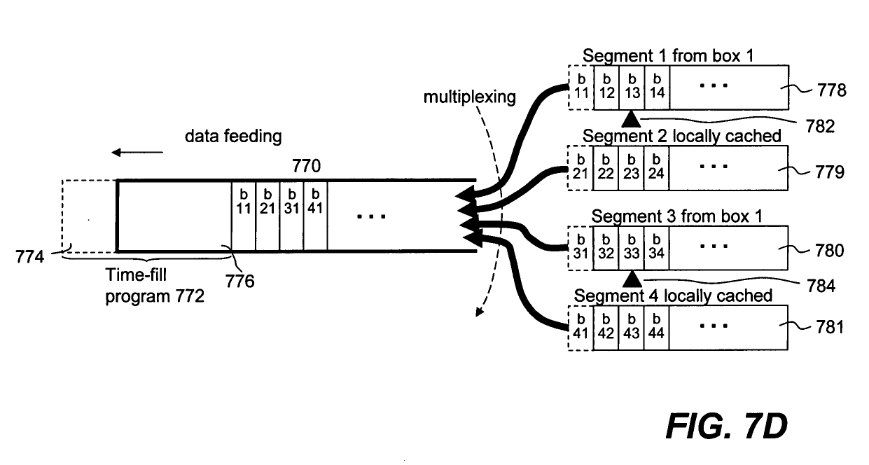

Referring to FIG. 7A, there shows an embodiment in which a file 720 is being organized or fragmented in terms of four segments 724. In general, the file 720 may be divided into any number of segments in consideration of a required transmission rate (e.g., related to the encoding and decoding rates for successful playback), and the minimum uploading and downloading capabilities of a network. FIG. 7B shows another embodiment in which a file 730 is being organized or fragmented in terms of a header 732 and four segments 724, where the header 732 is always locally cached. One of the advantages of having a header locally cached is to facilitate an instantaneous playback after a movie is order. For example, as shown in the display 320 of FIG. 3B, after a user activates “Watch It Now”, assuming that a financial arrangement is already in place, the header for the ordered movie in the box 608 is immediately played back. While the header is being played back, the needed segments are retrieved from other designated boxes. It can be appreciated the length of a header may be predefined or dynamically determined to provide a time buffer (e.g., 5 minutes) sufficiently to retrieve part of the data from the distributed segments for assembling with that of any locally cached segments, if any. As a result, an instantaneous VOD system may be realized.

Regardless whether a header is used or not, a file or a majority of a file will be fragmented and the segments are distributed among the boxes in service. According to one embodiment, given a required transmission rate (e.g., 1 megabit per second or 1 Mbps), the minimum uploading and downloading speeds of a network are considered to determine a number that defines the segmentation, and thus the dependency on other boxes and the support for concurrent demands of a particular title.

It is assumed that a minimum uploading speed is U and a required transmission rate is D, and D/U=K<k, where k is the smallest integer greater than K. In one embodiment, a file or a majority of a file is preferably divided into k segments to optimally utilize the uploading speed of U, assuming that the downloading speed is at least k times faster than the uploading speed. For example, in a POTS-based DSL network for residential areas, the required transmission may be about 1.0 Mbps while the uploading speed may be about 300 kbps. Hence, k=4. Assuming that the ordering box 608 has a downloading speed four times the uploading speed of the other boxes, the three segments in boxes 606-n, 606-3 and 606-1 can be downloaded concurrently across the network 602 as streaming into the ordering 608 without interruption.

FIG. 7C shows a data stream 740 representing a file or a majority of a file. The file 740 is divided into four segments 747-750. The segments 247-250 are created or formed by respectively sampling the file in a decimated manner. As a result, each of the segments includes a plurality of data blocks. Depending on an exact data length of the file 240, an n-th data block in each of the segments 247-250 is four successive data blocks in the file. In one embodiment, a data block comprises a chunk of data, for example, 256 Kbytes or 1 Mbyte.

As shown in FIG. 7C, the data stream 740 is expressed in data blocks as follows: b11, b21, b31, b41, b12, b22, b32, b42, b13, b23, b33, b43, . . . b1n, b2n, b3n, b4n. With the decimated sampling, the four segments 747-750 obtained can be respectively expressed as follows:

Segment 1={b11, b12, b13, b14 . . . };

Segment 2={b21, b22, b23, b24 . . . }

Segment 3={b31, b32, b33, b34 . . . }; and

Segment 4={b41, b42, b43, b44 . . . }.

It should be noted, however, a header, if used, includes data blocks that must be consecutive so that an instantaneous playback of the header is possible.

Referring now to FIG. 7D, there shows an embodiment of retrieving and assembling segments to support a playback of a selected movie. If all segments are streaming at predetermined minimum speeds, then, at 756, portions of the segments locally stored and the portions of the segments being streamed in are multiplexed into a buffer as shown in FIG. 7D. a portion 774 of the time-fill program 772 has been played out of the buffer 770. The remaining portion 776 of the time-fill program 772 is yet to be played. At the same time, the streaming of segments 778 and 780 is being fed into the buffer 770. Segments 778-781 (including the segments locally stored and the segments being streamed in) are multiplexed into the buffer 770. More specifically, a block of data from segment 1, a block of data from segment 2, a block of data from segment 3 and a block of data from segment 4 are multiplexed and successively fed into the buffer 770. As a result, the original order of the data is restored and the remaining portion of the file pertaining to the title is assembled.

To facilitate the continuation of a data stream, each of the pointers 782 and 784 is used to remember where the data block of a segment is being fed or about to be fed to the buffer 770. In the event, the segment being fetched from a box is interrupted and a backup box needs to step in, the ordering box knows exactly where to start fetching the segment from where it was interrupted in accordance with the pointer. Likewise, similar pointers (not shown) may be provided to remember where the data block of the locally cached segment is being fed or about to be fed to the buffer 770. In the event, the ordering box needs to be reset or is suddenly powered off and back on, these pointers can facilitate the continuation of the playback of the ordered movie.

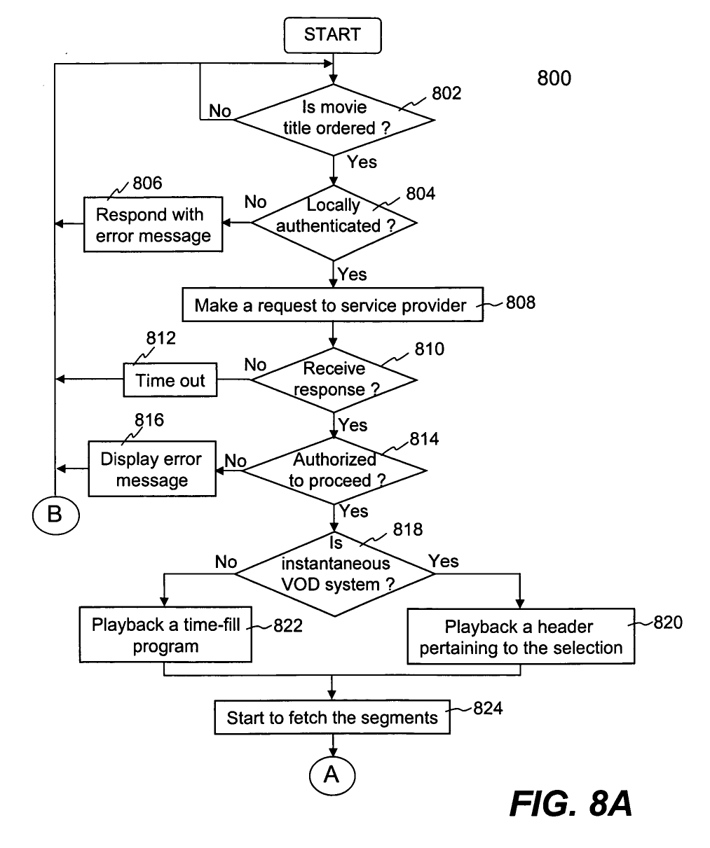

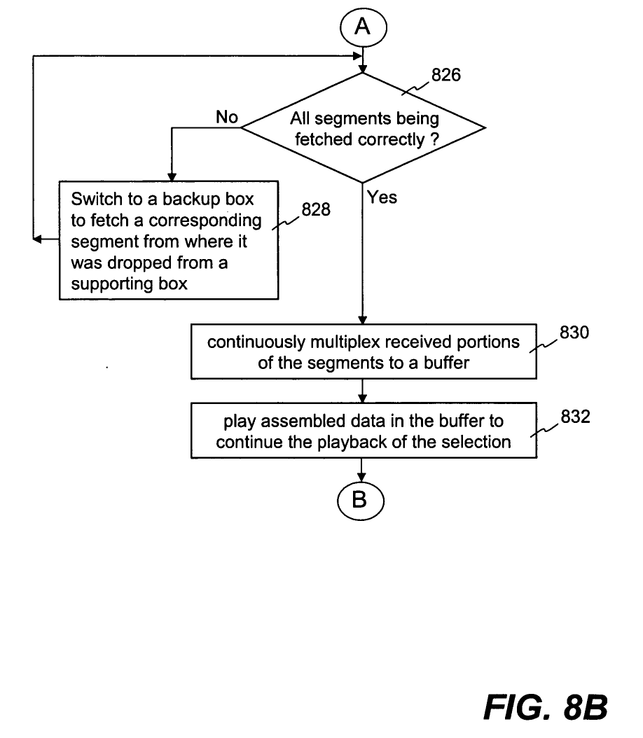

Referring now to FIG. 8A and FIG. 8B, both figures collectively show a flowchart or process 800 of starting a playback of a selection (i.e., a movie title). The process 800 may be implemented in software, hardware or a combination of both as a method, a process, and/or a system. In one embodiment, the process 800 is implemented as an application module and stored in the memory 512 of FIG. 5A. When the application module is executed by the micro-controller 506, the terminal device plays back a selected movie, wherein the file pertaining to the selected movie is in most cases distributed in a network and to be retrieved as streaming data to the terminal device.

At 802, the process 800 awaits a selection from a user. In one case, a user views a display with a plurality of titles from which the user may activate a key (e.g., on a remote control or keyboard) to choose one of the titles. The process 800 is activated after a selection is made by the user. The process 800 goes to 804 to determine whether the user and/or box is properly authenticated. In one embodiment, a registered user is required to input a username and a password for authentication.

In another embodiment, a registered user is required to enter a code for authentication. There may be other ways to authenticate a user. In any case, the process 800 needs to ensure that a user or a box is legitimate before, for example, the display 200 of FIG. 2A can be accessed or displayed. If not, the user is sent an error message at 806 that may recommend that the user register with the system.

After a registered user has been authenticated at 804, the box sends a request at 808 in accordance with the selection. The request includes information about the order and the user (or the box associated with). The request is transported to the server by a service provider. Upon receiving the request, the server determines a set of boxes designated to supply the needed segments to the ordering box. Meanwhile, the box awaits a response from the server at 810. The request may be re-sent if a response is not received within a predefined time (e.g., 5 seconds). However, if the response is not received beyond a certain time (e.g., the network is down), an error message will be displayed at 812.

At 814, the response is received from the server. For some reason, the response may restrict the user from using the system. If the user is restricted, the process 800 goes to 816 to display an error message to the user. If the user is fully authorized to proceed, the process 800 goes to 818.

As described before, there are at least two possible implementations of a VOD system in accordance with the present invention, one being instantaneous and the other one being expected delay. If the implantation is for instantaneous playback, which means that a small beginning portion of a movie is locally cached, the header is immediately played back at 820. If the implementation is for delayed playback, which means that no data is immediately available for playback, a time-fill program is immediately activated at 822. Nevertheless, the time-fill program could be played back even when a header is locally cached. Such a mode of operation may be desirable for many reasons: (a) to enable the creation of a large “buffer” of downloaded content before the movie is played back; (b) to simulate a theatrical movie-watching experience for the user by playing trailers ahead of the main movie; (c) to provide a platform to generate revenues via the playback of commercial programs. In either case, the process 800 goes to 824, the ordering box at 824 starts to fetch the missing segments from the designated boxes.

To timely start the delayed playback of an ordered movie or continue the playback of an ordered movie, the missing segments are expected to arrive at a predetermined speed at 826. If, for some reason, a portion of the network is congested or the box itself is malfunctioning, causing a significant slowdown of the segment being fetched, the process 800 goes to 828, where a backup box is called in to continue supplying the segment being interrupted.

If all segments are streaming at predetermined minimum speeds, then, at 830, portions of the segments locally stored and the portions of the segments being streamed in are multiplexed into a buffer as shown in FIG. 7D. The process 800 goes to 832 to continue the playback of the assembled data in the buffer until the entire file for the ordered movie is played. The process 800 then goes back to 802 to await another order from the user.

One skilled in the art will recognize that elements of the present invention may be implemented in software, but can be implemented in hardware or a combination of hardware and software. The invention can also be embodied as computer-readable code on a computer-readable medium. The computer-readable medium can be any data-storage device that can store data which can be thereafter be read by a computer system. The computer-readable media can also be distributed over network-coupled computer systems so that the computer-readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, some elements in a display may include one or more sub-elements. When such an element is selected, the display appearance of the element may be highlighted in a way that enables the user to navigate into the sub-elements to select one of the sub-elements or group one or more of these sub-elements. Accordingly, the scope of the present invention is defined by the appended claims rather than the foregoing description of embodiments.

1. A method for presenting movie titles on a display, the method comprising:
displaying a functional panel that enables a user to perform any one of a plurality of actions, including one or more actions to enable the user to browse the movie titles and to search the movie titles for a first movie title;
in response to the user selecting one of the plurality of actions, displaying a list of movie titles associated with the selected action, wherein each of the listed movie titles may be selected for playback by the user;
in response to the user selecting one of the movie titles for playback, determining whether to (i) initiate playback of a movie corresponding to the selected title, or (ii) present a first media content on the display; and
playing back the selected movie after a first interval of time based, at least in part, on the determination.

2. The method as recited in claim 1, wherein each of the listed movie titles is presented as a graphical image corresponding to at least part of a movie poster.

3. The method as recited in claim 1, wherein a data file pertaining to the selected movie is segmented into a plurality of data segments, including a header segment and plurality of tail segments, and wherein the header segment corresponds to a beginning portion of the movie and the plurality of tail segments collectively correspond to the remaining portion of the movie.

4. The method as recited in claim 3, further comprising retrieving one or more of the data segments, via a network from a set of devices coupled to the network.

5. The method as recited in claim 4, wherein determining whether to (i) initiate playback of a movie corresponding to the selected title, or (ii) present a first media content on the display, comprises:
determining a number of data segments required to enable continuous playback of the selected movie; and
determining a duration of time needed to obtain the number of data segments.

6. The method as recited in claim 5, wherein the first interval of time is at least equal to the duration of time needed to obtain the number of data segments.

7. The method as recited in claim 5, wherein playing back the selected movie comprises:
presenting the first media content for at least the duration of time needed to obtain the number of data segments; and
initiating playback of the selected movie upon completing the presentation of the first media content.

8. The method as recited in claim 7, wherein the first media content includes one or more of: (i) texts, (ii) pictures, (iii) trailers, (iv) previews or (v commercial information.

9. The method as recited in claim 7, wherein the first media content comprises a number of commercial programs that are determined and presented in accordance with an auction process among respective sponsors of the commercial programs.

10. The method as recited in claim 1, wherein the first media content includes information pertaining to one or more of various events, updates or commercial promotions.

11. The method as recited in claim 10, further comprising selecting the one or more various events updates or commercial promotions based, at least in part, on one or more interests or characteristics of the user.

12. (canceled)

13. The method as recited in claim 1, further comprising:
displaying a plurality of movie titles being promoted or advertised wherein each of the movie titles being promoted or advertised is presented as a graphical image that is selectable by the user; and
in response to the user selecting one of the movie titles being promoted or advertised, displaying a movie review associated with the selected movie title.

14. (canceled)

15. The method as recited in claim 13, further comprising, in response to the user selecting one of the movie titles being promoted or advertised, enabling the user to: (i) archive the selected movie title, (ii) request playback of media content corresponding to the selected movie title, or (iii) search for other movie titles based, at least in part, on information pertaining to the selected movie title.

16. The method as recited in claim 15, wherein displaying a movie review associated with the movie title includes concurrently displaying at least: (i) a trailer, (ii) a movie poster, (iii) a synopsis, (iv) a rating, (v) a length of playback, and (vi) a production company associated with the movie title.

17. The method as recited in claim 1, wherein the plurality of actions further includes at least one of: (i) organize a personalized list of movie titles, (ii) manage one or more user accounts, or (iii) configure one or more user preferences.

18. The method as recited in claim 1, further comprising, in response to the user selecting one of the listed movie titles for playback, displaying a list of personnel associated with the selected movie title.

19. The method as recited in claim 18, wherein the list of personnel includes one or more actors, directors, or crew members involved with the corresponding movie.

20. An apparatus for presenting movie titles in a library, the apparatus comprising:
a memory device for storing at least an application module;
a processor, coupled to the memory device, to receive inputs from a user the processor being configured to:
generate display data corresponding to a functional panel that enables the user to perform any one of a plurality of actions, including one or more actions to enable the user to browse the movie titles and to search the movie titles for a first movie title;
in response to the user selecting one of the plurality of actions, generate a list of movie titles associated with the selected action, wherein each of the listed movie titles may be selected for playback by the user;
in response to the user selecting one of the movie titles for playback, determine whether to (i) initiate playback of a movie corresponding to the selected title, or (ii) present a first media content to the user; and
play back the selected movie after a first interval of time based, at least in part, on the determination.

21. The apparatus as recited in claim 20, wherein each of the listed movie titles is presented as a graphical image corresponding to at least part of a movie poster.

22. The apparatus as recited in claim 20, wherein a data file pertaining to the selected movie is segmented into a plurality of data segments, including a header segment and a plurality of tail segments, and wherein the header segment corresponds to a beginning portion of the movie and the plurality of tail segments collectively correspond to the remaining portion of the movie.

23. The apparatus as recited in claim 22, wherein the processor is further configured to retrieve one or more of the data segments, via a network, from a set of devices coupled to the network.

24. The apparatus as recited in claim 23, wherein the processor is further configured to:
determine a number of data segments required to enable continuous playback of the selected movie; and
determine a duration of time needed to obtain the number of data segments.

25. The apparatus as recited in claims 24, wherein the first interval of time is at least equal to the duration of time needed to obtain the number of data segments.

26. The apparatus as recited in claim 24, wherein the processor is further configured to:
present the first media content for at least the duration of time needed to obtain the number of data segments; and
initiate playback of the selected movie upon completing the presentation of the first media content.

27. The apparatus as recited in claim 26, wherein the first content item includes one or more of: (i) texts, (ii) pictures, (iii) trailers, (iv) previews or (v) commercial information.

28. The apparatus as recited in claim 26, wherein the first content item comprises a number of commercial programs that are determined and presented in accordance with an auction process among respective sponsors of the commercial programs.

29. The apparatus as recited in claim 20, wherein the first content item includes information pertaining to one or more of various events, updates or commercial promotions.

30. The apparatus as recited in claim 29, wherein the processor is further configured to select the one or more various events, updates or commercial promotions based, at least in part, on one or more interests or characteristics of the user.

31. (canceled)

32. The apparatus as recited in claim 20, wherein the processor is further configured to:
generate display data corresponding to distinctively a plurality of movie titles being promoted or advertised, wherein each of the movie titles being promoted or advertised is presented as a graphical image that is selectable by the user; and
in response to the user selecting one of the movie titles being promoted or advertised, generate display data corresponding to a movie review associated with the selected movie title.

33. (canceled)

34. The apparatus as recited in claim 32, wherein in response to the user selecting one of the movie titles being promoted or advertised, the processor is further configured to enable the user to: (i) archive the selected movie title, (ii) request playback of media content corresponding to the selected movie title, or (iii) search for other movie titles based, at least in part, on information pertaining to the selected movie title.

35. The apparatus as recited in claim 34, wherein the display data corresponding to the movie review includes at least: (i) a trailer (ii) a movie poster, (iii) a synopsis, (iv) a rating, (v) a length of playback, and (vi) a production company associated with the movie title.

36. The apparatus as recited in claim 20, wherein the plurality of actions further includes at least one of: (i) organize a personalized list of movie titles, (ii) manage one or more user accounts, or (iii) configure one or more user preferences.

37. The apparatus as recited in claim 20, wherein in response to the user selecting one of the movie titles for playback, the processor is further configured to generate display data corresponding to a list of personnel associated with the selected movie title.

38. The apparatus as recited in claim 37, wherein the list of personnel includes one or more actors directors, or crew members involved with the corresponding movie.
